(19) United States
(12) Patent Application Publication
(10) Pub. No.: US 2024/0232301 A1
(43) Pub. Date: Jul. 11, 2024

(54) PROTECTED DATA PACKAGES

(71) Applicant: Irdeto B.V., Hoofddorp (NL)

(72) Inventor: Yaozhang CAI, Beijing (CN)

(21) Appl. No.: 18/577,194

(22) PCT Filed: Jul. 8, 2021
(86) PCT No.: PCT/CN2021/105154

§ 371 Date: Jan. 5, 2024

(51) Int. Cl. G06F 21/14; G06F 21/56

(52) U.S. Cl. CPC G06F 21/14; G06F 21/565

(57) ABSTRACT

There is described a method of generating a protected data package from an initial file. The initial file has a predetermined file format, the method comprises: (a) identifying a code portion of the initial file to be protected; (b) generating a supplementary file comprising a copy (or version) of the code portion; and (c) modifying the initial file, wherein the modifying comprises replacing at least the code portion of the initial file with replacement data to thereby provide a modified file, wherein the modified file has the same predetermined file format as the initial file, and wherein the modification is arranged to cause a failure when a reader for the predetermined file format tries to load the code portion from the modified file. The protected data package comprises the modified file and the supplementary file. There is also described a method for a reader of a predetermined file format to execute a protected data package. The protected data package comprises a modified file and a supplementary file. The modified file comprises replacement data that has replaced at least a code portion of an initial file on which the modified file is based. The modified file and the initial file have the predetermined file format. The supplementary file comprises a copy (or version) of the code portion. The method comprising, at runtime: responsive to a failure when trying to load the code portion from the modified file, processing the supplementary file so as to load the code portion from the supplementary file.

### FIELD OF THE INVENTION

The present invention relates to generating and executing protected data packages. In particular the methods described herein are useful for protecting .dex files and Java class files.

### BACKGROUND OF THE INVENTION

A Java compiler is used to compile Java source code into a Java class file (with the .class filename extension) containing Java bytecode that can be executed on the Java Virtual Machine (JVM). A .jar file is a package file format typically used to aggregate many .class files and associated metadata and resources (text, images, etc.) into one file for distribution.

Android devices use an alternative bytecode format called Dalvik. The dx tool/compiler, which is part of the Android software development kit (SDK), is used to convert .class files and any .jar libraries into a .dex file (i.e. a Dalvik executable file) containing Dalvik bytecode. .dex files have a predetermined format defined by Google Android, and can be run in a Dalvik Virtual Machine (DVM). The dx tool eliminates all the redundant information that is present in the classes by packing all of the classes of the application into a single .dex file.

When the Android system executes a .dex file, it maps the entire .dex file to continuous memory space, and the memory address of the entire mapped .dex file can be easily found in the Android file system/proc/{pid}/maps file (where pid is the ID of current running process which loaded the .dex file). A basic knowledge of Linux and reverse engineering enables an attacker to easily find the memory address of the mapped .dex file and dump it from memory to file.

Because the format of a .dex file is predetermined and public, and because there are a lot of tools that can reverse engineer or tamper with a .dex file, it is desirable to protect .dex files from illegal tampering and reverse engineering. Thus, an application developer often applies certain .dex protection tools to encrypt a .dex file before publishing it. The encrypted .dex file is then only decrypted and released to memory at runtime. Thus, this approach can protect .dex files from static attacks. However, because the Android system requires a plain .dex file for execution, an attacker can still access the .dex file in memory, and can then either tamper with the data of the .dex file in memory or dump the clear .dex file from memory to file.

The present invention seeks to provide an alternative way of protecting files (such as .dex files) which provides various advantages over those of the prior art.

### SUMMARY OF THE INVENTION

According to a first aspect of the present invention, there is provided a method of generating a protected data package from an initial file. The initial file has a predetermined file format, the method comprises: (a) identifying a code portion of the initial file to be protected; (b) generating a supplementary file comprising a copy (or version) of the code portion; and (c) modifying the initial file, wherein the modifying comprises replacing at least the code portion of the initial file with replacement data to thereby provide a modified file, wherein the modified file has the same predetermined file format as the initial file, and wherein the modification is arranged to cause a failure when a reader for the predetermined file format tries to load the code portion from the modified file. The protected data package comprises the modified file and the supplementary file.

According to a second aspect of the present invention, there is provided a protected data package generated according to the method of the first aspect.

According to a third aspect of the present invention, there is provided a method for a reader of a predetermined file format to execute a protected data package. The protected data package comprises a modified file and a supplementary file. The modified file comprises replacement data that has replaced at least a code portion of an initial file on which the modified file is based. The modified file and the initial file have the predetermined file format. The supplementary file comprises a copy (or version) of the code portion. The method comprising, at runtime: responsive to a failure when trying to load the code portion from the modified file, processing the supplementary file so as to load the code portion from the supplementary file.

Other preferred features of the present invention are set out in the appended claims.

### BRIEF DESCRIPTION OF THE DRAWINGS

Embodiments of the present invention will now be described by way of example with reference to the accompanying drawings in which:

FIG. 1 schematically illustrates the predetermined structure/format of a .dex file.

FIG. 2 schematically illustrates an example of a class_def_item of a .dex file.

FIG. 3 schematically illustrates an example of a class_data_item of a .dex file.

FIG. 4 schematically illustrates an exemple of a code_item 400 of a .dex file.

FIG. 5 is a flow chart illustrating a method of generating a protected data package from an initial file.

FIG. 6 schematically illustrates an offline tool used to perform the method of FIG. 5.

FIG. 7 is a flow chart illustrating a method for a reader of a predetermined file format to execute a protected data package generated according to the method of FIG. 5.

FIG. 8 is a flow chart illustrating sub-steps of the method of FIG. 7. In particular, FIG. 8 is a flow chart illustrating the processing of a supplementary file so as to load a code portion from the supplementary file.

FIG. 9A shows a default sequence of class loaders in a reader for a predetermined file format.

FIG. 9B shows an adjusted sequence of class loaders in a reader for a predetermined file format.

FIG. 10 is a flow chart illustrating sub-steps of loading a code portion to heap memory on demand.

FIG. 11 shows an exemplary .class file data structure.

### DETAILED DESCRIPTION OF A PREFERRED EMBODIMENT

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader spirit and scope of the invention as set forth in the appended claims.

One example of a predetermined file format is a .dex file format. This example will be described in detail below. Subsequently, a further example is described based on Java class file format (.class files).

### 1: .dex File Format

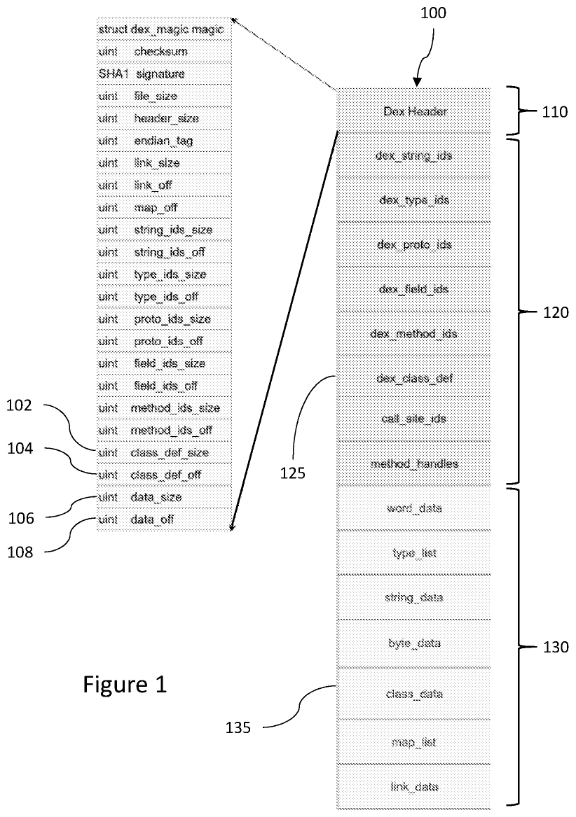

For the full content of a .dex file, please refer to the official Android document found at https://source.android.com/devices/tech/dalvik/dex-format. However, FIG. 1 schematically illustrates the predetermined structure/format of a .dex file 100.

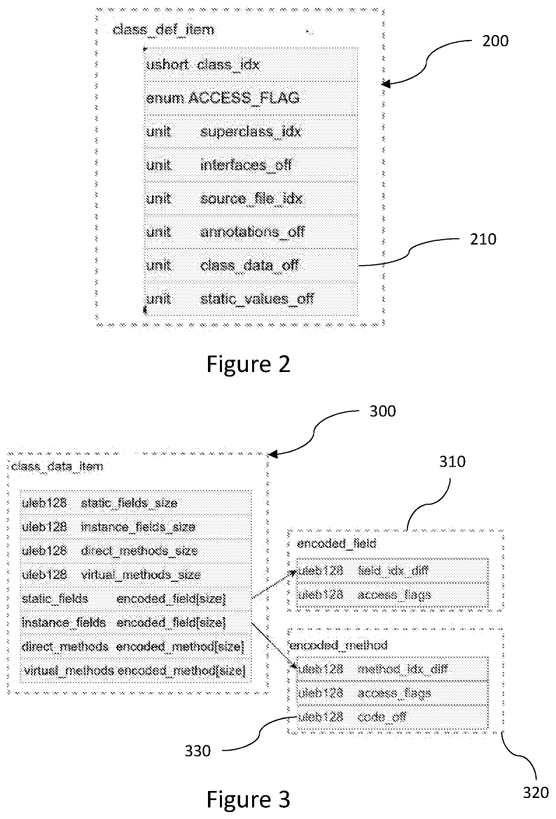

As shown in FIG. 1, a .dex file includes a header 110, a list section 120, and a data section 130. The header is shown in expanded form on the left hand side of FIG. 1. The dex_class_def list 125 in the list section 120 is a list of class definitions, each referred to as a class_def_item. An example of a class_def_item 200 is schematically illustrated in FIG. 2.

Referring back to FIG. 1, the header 110 includes class_def_size 102 and class_def_off 104 which specify the size and location of the dex_class_def list 125. The header 110 also includes data_size 106 and data_off 108 which specify the size and location of the data section 130.

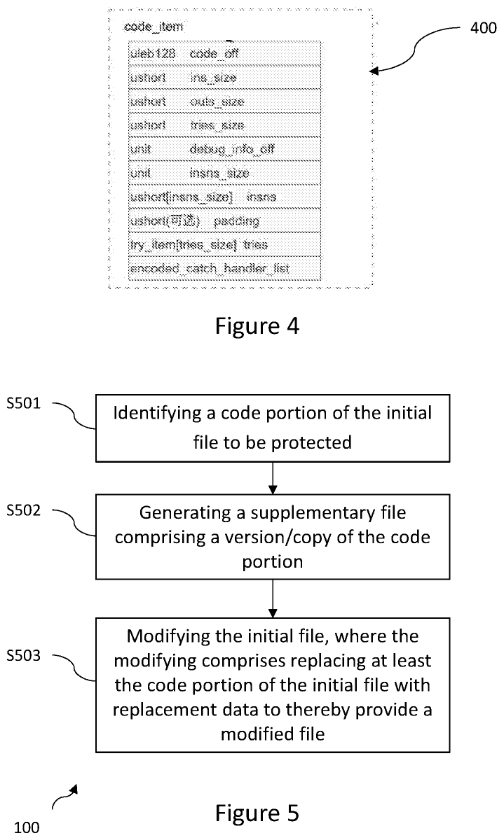

The class_data section 135 in the data section 130 is a data area for all the class data corresponding to the classes defined in the dex_class_def list 125. The data for a particular class is referred to as a class_data_item. An example of a class_data_item 300 is shown schematically in FIG. 3. Each class_data_item 300 may include an encoded_field 310 and an encoded_method 320. The encoded_method 330 is a particular method for the particular class of the class_data_item 300. The encoded_method 330 includes a code_off 330, which specifies a location of a related code_item in the data section 130. The code_item is the actual code relating to the particular method. An exemplary code_item 400 is schematically illustrated in FIG. 4.

### 2: Offline Tool

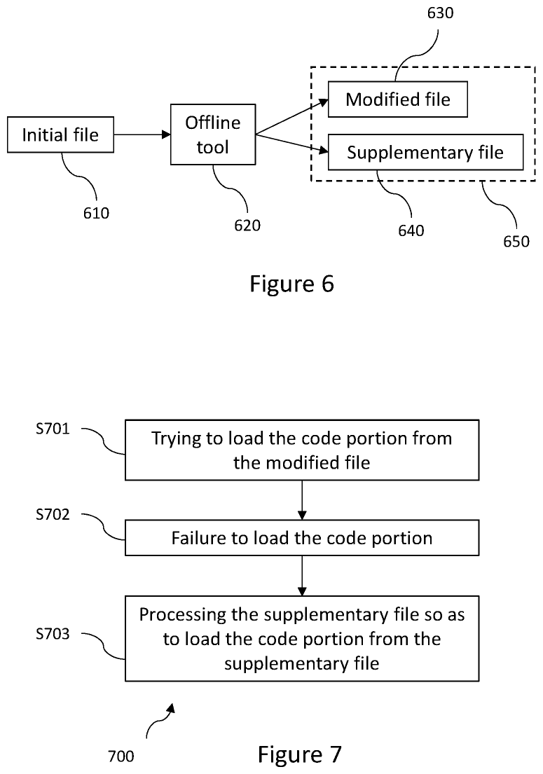

FIG. 5 schematically illustrates a method 500 of generating a protected data package from an initial file. The method 500 is generally performed offline by an offline tool 620, as is schematically illustrated in FIG. 6. In particular, the offline tool 620 starts with an initial file 610, and generates a modified file 630 and a supplementary file 640, which together form the protected data package 650.

The initial file 610 has a predetermined file format. In the example described in this section, the predetermined file format is the .dex file format. However, protection of other predetermined file formats are also envisaged. For example, a further example is given below in section 4 in relation to Java class files (i.e. .class file format).

The method comprises a first step S501 of identifying a code portion of the initial file 610 to be protected. In particular, the first step S501 identifies the bytecode of the relevant code portion within the initial file 610. The step S501 of identifying the code portion to be protected may comprise parsing the initial file 610 to identify the code portion and/or to identify a pointer referencing a location of the code portion in the initial file. When the initial file 610 is a .dex file 100, the code portion may be associated with a particular class of the .dex file 100.

In a first example, it is desired to protect the entirety of a particular class of the .dex file 100. In this example, the code portion to be protected is the class_data_item 300 shown in FIG. 3, and the step S501 of identifying the code portion of the initial file 610 to be protected may comprise a number of sub-steps. A first sub-step comprises parsing the header 110 of the .dex file 100 to obtain class_def_off 104 and data_off 108. A second sub-step comprises, based on the class_def_off 104, parsing the class_def_item 200 associated with the particular class to obtain class_data_off 210 for the particular class. A third sub-step comprises, based on the data_off 108 and the class_data_off 210, obtaining the class_data_item 300 associated with the particular class. In other words, this third sub-step involves seeking to class_data 135 in the data section 130 of the .dex file, and getting the class_data_item 300. A fourth sub-step comprises identifying the class_data_item 300 as the code portion of the initial file 610 to be protected. In this first example, the pointer referencing the location of the code portion in the initial file 610 includes the class_data_off 210.

In a second example, it is desired to protect a particular method of a particular class of the .dex file 100. In this example, the code portion to be protected is the code_item 400, and the step S501 of identifying the code portion of the initial file 610 to be protected may comprise a number of sub-steps. A first sub-step comprises parsing the header of the .dex file 100 to obtain class_def_off 104 and data_off 108. A second sub-step comprises, based on the class_def_off 104, parsing the class_def_item 200 associated with the particular class to obtain class_data_off 210 for the particular class. A third sub-step comprises, based on the data_off 108 and the class_data_off 210, parsing the class_data_item 300 associated with the particular class to obtain encoded_method 320 associated with the particular method. In other words, this third sub-step involves seeking to class_data 135 in the data section 130 of the .dex file, and getting the class_data_item 300, then parsing the class_data_item 300 to get the encoded_method 320. A fourth sub-step comprises parsing the encoded_method 320 to obtain code_off 330 for the particular method. A fifth sub-step comprises, based on the code_off 330, obtaining code_item 400 for the particular method. In other words, this fifth sub-step involves seeking to the code_item 400 by the code_off 330 and getting the real method data (i.e. the code_item 400). A sixth sub-step comprises identifying the code_item 400 as the code portion of the initial file 610 to be protected. In this second example, the pointer referencing the location of the code portion in the initial file 610 includes the code_off 330.

In further examples, the code portion to be protected may include at least one class_data_item 300 and at least one code_item 400.

The method comprises a second step S502 of generating a supplementary file 640 comprising a copy (or version) of the code portion. For example, the supplementary file 640 may contain a copy of the relevant class_data_item 300 and/or code_item 400 (or multiples thereof). The supplementary file 640 may further comprise a pointer which references a location of the code portion in the supplementary file 640. For example, the supplementary file 640 may contain pointers which reference locations of the relevant class_data_item 300 and/or code_item 400 (or multiples thereof) in the supplementary file 640. These pointer(s) in the supplementary file 640 may be offsets.

Metadata relating to the relevant code portion (e.g. the relevant class_data_item 300 and/or code_item 400) may further form part of the supplementary file 640. For example, when the code portion is a class_data_item 300, as part of the second step S502 of generating the supplementary file 640, the offline tool 620 may parse the length of the relevant class_data_item 300 and save it as metadata within the supplementary file 640. The length of the class_data_item 300 may be obtained by subtracting the offset 210 for that class_data_item 300 from the offset for the next class_data_item. A similar approach may be used to provide metadata in the supplementary file 640 where in the code portion includes a code_item 400.

The method comprises a third step S503 of modifying the initial file 610. The modification in step S503 comprises replacing at least the code portion of the initial file 610 with replacement data to thereby provide a modified file 630. Thus, the modified file 630 is a copy of the initial file 610 with at least the code portion replaced by replacement data. The replacement data is the same size as the replaced data (which includes the code portion). In other words the number of bytes of data is the same in each case. This means that the modified file 630 retains the same predetermined file format (and file size) as the initial file 610. For .dex files (and other files which specify offsets to particular data structures in a similar manner), this means that the majority of the specified offsets (e.g. the class_def_off 104 and the data_off 108) are still valid in the modified file 630. Offsets will only become invalid following step S503 if the offsets themselves are intentionally replaced by part of the replacement data. In a preferred example, the replacement data comprises random data and/or null data.

The modification in step S503 is arranged to cause a failure when a reader for the predetermined file format tries to load the code portion from the modified file 630. This will be discussed in further detail in the ‘Runtime processing’ section below. However, it will be generally understood that replacing a code portion of an initial file 610 with, e.g., null or random replacement data will mean that the modified file 630 does not have the right type of data where the code portion should be. Thus, any validation procedures or checks on the expected code portion (i.e. on the replacement data) will tend to fail.

The protected data package 650 generated by the method 500 comprises the modified file 630 and the supplementary file 640. The supplementary file 640 may be considered as metadata to supplement the modified file 630.

### 3: Runtime Processing

At runtime, it is desired that a reader of the predetermined file format will be able to execute a protected data package that has been generated according to the above methodology (i.e. the method 500 of FIG. 5). In other words, it is desired that the same reader that is normally used to read the predetermined file format will also be able to read the protected data package. For example, a .dex file reader should also be able to read a protected data package generated based on an initial .dex file. This is achieved by a method in which, at runtime, responsive to a failure when trying to load the code portion from the modified file 630 (e.g. the modified .dex file), the supplementary file 640 is processed so as to load the code portion from the supplementary file 640.

FIG. 7 schematically illustrates such a method 700 for a reader of a predetermined file format to execute a protected data package. The method 700 is generally performed at runtime by a reader of the predetermined file format. As in the previous section, we here describe an example where the predetermined file format is the .dex file format. In this .dex example, the reader will generally be a .dex file reader on an Android device, such as an Android mobile phone. However, protection of other predetermined file formats is also envisaged. For example, a further example is given below in section 4 in relation to Java class files (i.e. .class file format).

In the runtime method 700, the protected data package 650 to be executed comprises the modified file 630 and the supplementary file 640. As described above, the modified file 630 comprises replacement data that has replaced at least a code portion of the initial file 610 on which the modified file 630 is based. As discussed above, the replacement data may comprise random data and/or null data, for example. The modified file 630 and the initial file 610 both have the predetermined file format (e.g. .dex file format). The supplementary file 640 comprises a copy of the code portion.

Referring to FIG. 7, in a first step S701, the method 700 comprises the reader for the predetermined file format trying to load the code portion from the modified file 630. In this step, the reader is acting exactly as it would do normally in order to read any file of the predetermined file format. For example, if the initial file 610 is a .dex file, the reader would be a .dex file reader. In this case, the reader would attempt to read the modified .dex file 630 in exactly the same way as it would normally attempt to read a normal .dex file. In particular, the .dex file reader would map the entire modified .dex file 630 to continuous memory space. As discussed above, this means that the memory address of the entire modified .dex file 630 can be easily found in the Android file system/proc/{pid}/maps file. Note that much of the modified .dex file 630 will be readable by the .dex file reader because much of the file is unaltered and the format of the modified .dex file 630 is still the same as a normal .dex file, so any non-replaced offset values will still be valid.

Step S701 specifically comprises the reader for the predetermined file format trying to load the code portion from the modified file 630 (i.e. trying to load a part of the initial file 610 which has been replaced by replacement data in the modified file 630). However, given that the code portion has been replaced by replacement data (e.g. null or random data), trying to load the code portion leads to a loading failure in step S702. In other words, when the replacement data in the modified file 630 comprises first replacement data that replaces the code portion of the initial file 610, the loading failure in step S702 may be caused by the reader for the predetermined file format detecting that the first replacement data includes invalid data for the code portion. An alternative loading failure in step S702 may occur when a pointer in the initial file 610 references a location of the code portion in the initial file 610, and the replacement data in the modified file 630 comprises second replacement data that replaces the pointer. In this case, the loading failure in step S702 may be caused by the reader for the predetermined file format detecting that the second replacement data includes data other than a reference to a file location in the modified file 630. In other words, the second replacement data may be null or nonsense data which simply does not point to a particular file location such that the loading will fail when the reader attempts to interpret the second replacement data as a file location. Alternatively, the loading failure in step S702 may be caused by the reader for the predetermined file format detecting that the second replacement data includes a reference to a file location in the modified file 630, where the file location in the modified file 630 includes invalid data for the code portion. In other words, the second replacement data does point to a file location in the modified file 630, but it is the wrong file location (i.e. not the file location of where you would expect to find the code portion). In this case, the file location that has been pointed to will almost certainly include invalid data as compared to what was expected from the code portion, thereby causing a loading failure in step S702.

In one example, the initial file 610 is a .dex file and the code portion is associated with a particular class of the .dex file (e.g. the code portion includes a particular class_data_item 300 or a particular code_item 400 from a particular class_data_item 300). In this example, the loading failure in step S702 may occur when the reader for the predetermined file format uses a default class loader to try to load the code portion from the modified file 630. The default class loader will fail because the particular class is corrupted by the replacement data.

Responsive to the loading failure in step S702, step S703 comprises processing the supplementary file 640 so as to load the code portion from the supplementary file 640. In other words, following a failure to load the code portion from the modified file 630, the code portion is instead loaded from the supplementary file 640.

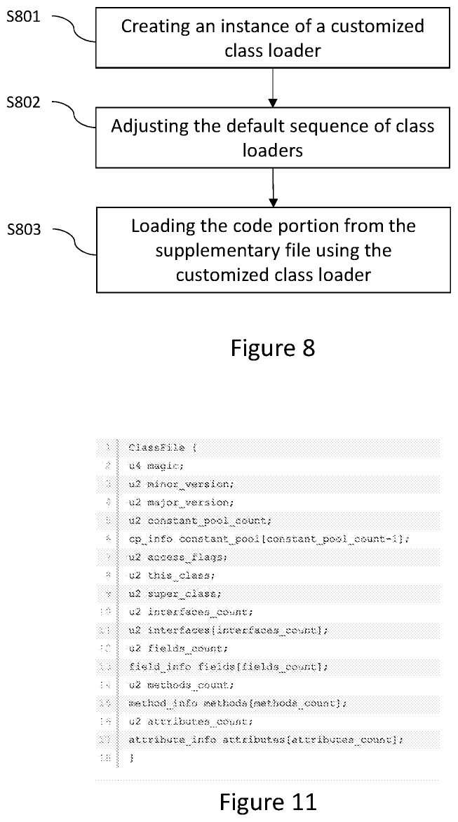

In the example above where the initial file 610 is a .dex file and the code portion is associated with a particular class of the .dex file, the step S703 of processing the supplementary file 630 so as to load the code portion from the supplementary file 630 may comprise a number of sub-steps, as shown in FIG. 8. A first sub-step S801 may comprise creating an instance of a customized class loader including instructions for loading the code portion from the supplementary file 630. A second sub-step S802 may comprise adjusting the default sequence of class loaders such that the customized class loader is called following failure of the default class loader to load the code portion from the modified file 630. The default class loader may be the DexClassLoader (see https://developer.android.com/reference/dalvik/system/DexClassLoader). The customized class loader inherits DexClassLoader but overrides the FindClass and LoadClass methods so that the customized class loader can be used to load the code portion from the supplementary file 640 at runtime. The customized class loader instance is created to include the path of the protected data package 650 and to include the PathClassLoader object (the class loader which contains the application's main .dex files). A third sub-step S803 may comprise loading the code portion from the supplementary file 640 using the customized class loader.

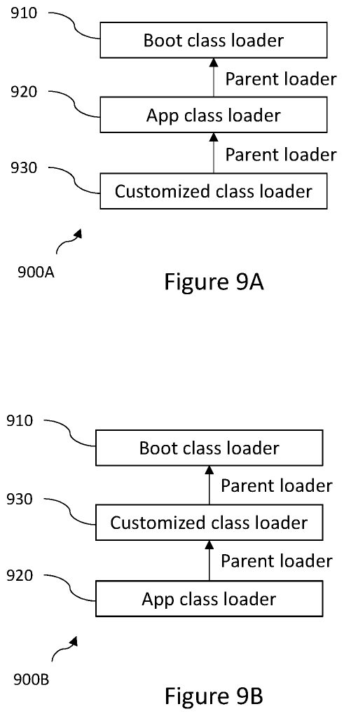

FIGS. 9A-B provide further details regarding the methodology of FIG. 8. In particular, FIG. 9A shows the default sequence 900A of class loaders in the reader for the predetermined file format, and FIG. 9B shows the adjusted sequence 900B of class loaders following the second sub-step S802 described above. In the default sequence 900A of class loaders in FIG. 9A, there is a boot class loader 910, which acts as a parent to an app class loader 920, which acts as a parent to the customized class loader 930. In the adjusted sequence 900B of class loaders in FIG. 9B, the boot class loader 910 is still at the top, but the app class loader 920 and the customized class loader 920 have been swapped. Thus, the boot class loader 910 acts as a parent to the customized class loader 930, which acts as a parent to the app class loader 920. Java's reflect mechanism may be used to adjust the default sequence of class loaders in the second sub-step S802 (e.g. this can be done by changing the private field mParentClassLoader in the customized class loader 930). See https://developer android.com/reference/java/lang/reflect/package-summary for further details about the reflect mechanism. The customized class loader 930 can then take over the class find and class load processes so as to load the code portion from the supplementary file 940. This also provides an opportunity to make changes to the loaded modified file 630 in memory.

Returning to FIG. 7, the step S703 of processing the supplementary file 630 so as to load the code portion from the supplementary file 640 may further comprise loading the code portion to heap memory on demand. As mentioned above, when the Android system executes a .dex file, it maps the entire .dex file to continuous memory space. Thus, the entirety of the modified .dex file 630 will have been loaded to continuous memory space in the heap by the .dex file reader. Whilst an attacker can access the entirety of the modified .dex file 630 from memory based on the Android system/proc/{pid}/maps file, this modified .dex file 630 only contains selected portions of the initial .dex file 610. In other words, the modified .dex file 630 is a corrupted version of the initial .dex file 610 and the content of the modified .dex file 630 is fragmentary. However, the code portion is only loaded to the heap on demand. This makes it much more difficult for an attacker to access the code portion. In other words, because the code portion (e.g. a particular class_data_item 300 and/or code_item 400) is loaded to memory on demand, it is very difficult for attacker to get all of the bytecode at one time.

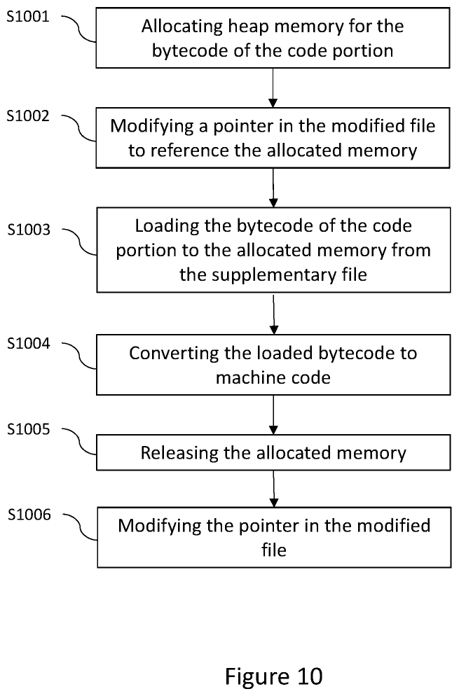

The on-demand code portion loading step may form part of sub-step S803 of FIG. 8. Loading the code portion to heap memory on demand may itself comprise a number of sub-steps, as shown in FIG. 10. A first sub-step S1001 may comprise allocating heap memory for the bytecode of the code portion. A second sub-step S1002 may comprise modifying a pointer in the modified file 630 to reference the allocated memory. A third sub-step S1003 may comprise loading the bytecode of the code portion to the allocated memory from the supplementary file 640. A fourth sub-step S1004 may comprise converting the loaded bytecode to machine code. A fifth sub-step S1005 may comprise releasing the allocated memory. A sixth sub-step S1006 may comprise modifying the pointer in the modified file 640 so that it no longer references the allocated memory. Thus, the pointer in the modified file 640 only points to the correct code portion memory location in the heap for a limited time (i.e. after the second to fifth sub-steps S1002-S1005). This makes it much harder for an attacker to access the code portion from memory.

In other words, once the default sequence of class loaders has been adjusted in sub-step S802 of step S703, sub-step S803 comprises loading the code portion from the supplementary file 640 using the customized class loader 930. This involves intercepting the loading process of the code portion using the customized class loader 930. It is known which code portion is to be loaded (i.e. we know which class_data_item 300 or code_item 400 is to be loaded), so it is possible to modify the relevant offset value(s) in the modified file 630 and to allocate heap memory for the code portion bytecode dynamically. In other words, for the particular class associated with the code portion, the reader can read all the class metadata from the modified file 630, and allocate heap memory for the bytecode of the code portion relating to that class. The relevant offset may then be modified accordingly. For example, if the code portion includes a class_data_item 300 for a particular class, then the metadata for that class_data_item 300 may be obtained from the supplementary file 640 (if this includes the relevant metadata), or from the modified file 630 itself. Based on this metadata, it is possible to allocate appropriate heap memory for the bytecode of the class_data_item 300, and to modify the associated offset (class_data_off 210) in the modified file 630. The bytecode of the class_data_item 300 is then loaded from the supplementary file 640 to the allocated heap memory. In other words, having relocated the class_data_item 300 to the new memory address, and having also changed the class_data_off 210, it is possible to seek to the new location of the class_data_item 300 by the new offset. Analogously, for a code portion comprising a particular code_item 400, having relocated the code_item 400 to the new memory address, and having also changed the code_off 330 in the relevant encoded_method 320, it is possible to seek to the new address of the code_item 400 by the new offset. Following successful loading of the relevant bytecode to the heap memory, the bytecode is converted into machine code and the allocated heap memory can be released, and the offset changed. Changing the offset at this stage ensures that the offset(s) for the relevant code portion in the modified .dex file 630 only point to the correct memory location(s) in the heap for a limited time when the code portion is being loaded from the supplementary file 640 to memory. This makes it much harder for an attacker to find and access the code portion on the heap.

Although the data offset has been modified and the code portion has been moved from the modified .dex file 630 to a new allocated memory, the .dex file structure is unchanged. Since the format of the modified file 630 is the same as the format of the initial file 610, the Android system is able to seek the relevant data by parsing the offset in a different data structure and seeking to corresponding memory address. In this way, the .dex file reader is still able to process the modified .dex file 630.

As noted above, the code portion (e.g. a particular class_data_item 300 and/or code_item 400) is loaded dynamically to heap memory, and that part of the heap memory is released once the Android system has finished converting the code portion bytecode to machine code. Thus, for an attacker, even if they can take the snapshot for the entire memory, they may only get very limited parts of the class_data_item 300 and/or code_item 400. Furthermore, even if an attacker were able to access the entire code portion from memory, it would then be necessary for them to spend considerable time restoring the initial .dex file 610 from the modified (i.e. corrupted) .dex file 630. Thus, the use of the protected data package 650 makes it very difficult for attackers to dump or tamper with protected .dex data packages 650.

In the prior art, it is known to encrypt a .dex file, or to use some other method of hiding the .dex file. However, in this case, when the .dex file needs to be loaded to a DWM on an Android device, it is necessary to decrypt or restore the encrypted/hidden .dex file in memory or on disk. This therefore presents a good opportunity for an attacker to access the .dex file in these prior art methodologies. In contrast, the present methodology enables core data of a .dex file (i.e. the selected code portion) to be moved from the usual .dex memory location to another location with the heap. Furthermore, the relevant offset(s) in the modified .dex file 630 are only changed to point to the right memory address(es) when Android needs to access that data (i.e. on demand). Thus, the present methodology prevents illegal memory dump or tampering of the .dex file at runtime. Furthermore, according to the present methodology, modifications are being made to software files (e.g. .dex files) in order to improve the runtime security of the software's execution, thereby providing a technical effect using technical means.

### 4: Java Class File Example

Java bytecode .class files have a similar file structure to .dex files in many ways, and can also benefit from the above described protection for .dex files, with some differences, as discussed below.

A .class file contains bytecode for all methods associated with that class. However, the data in a .class file is stored in serialization, so there is no “offset” concept in .class files and, when parsing a .class file, it is necessary to parse the different data structures one by one. FIG. 11 shows an exemplary .class file data structure. In order to seek to the access_flags field of FIG. 11, it is necessary to go through magic, minor_version, major_version, constant_pool_count and constant_pool[constant_pool_count-1], so as to seek to the correct location (or address or offset) of access_flags.

The method 500 of FIG. 5 may be used to generate a protected data package 650 from an initial .class file 610 associated with a particular class. The first step S501 of the method 500 is to identify the code portion to be protected. Notably, the bytecode of the .class file methods are placed in methods[methods_count]. In general, these methods contain the code that it is desired to protect (much as the class_data_item 300 and code_item 400 contain the code that it is most desirable to protect in a .dex file). Thus, for an initial .class file 610, the code portion to be protected includes the methods[methods_count]. In this case, the step S501 of identifying the code portion to be protected comprises (a) parsing the initial .class file 610 for the particular class to obtain methods[method count], and (b) identifying the methods[method count] as a part of the code portion. Rather than protecting the entirety of the methods[method count], is alternatively possible to protect only particular method(s) of the methods[method count]. As in step S502 of the method 500, a supplementary file 640 is generated to include a copy of the code portion from the initial .class file 610. As in step S503 of the method 500, the initial .class file is modified, where the modification comprises replacing at least the code portion of the initial .class file with replacement data to thereby provide a modified .class file 640. This methodology is performed by an offline tool 620.

The method 700 of FIG. 7 may be used by a .class file reader to to execute a protected data package. Specifically, at runtime, responsive to a failure when trying to load the code portion from the modified .class file 630, the supplementary file 640 is processed so as to load the code portion from the supplementary file 640 instead. In this case, the loading failure of step S702 of FIG. 7 occurs when using a default class loader to try to load the code portion from the modified .class file 630. At runtime, a customized class loader is created (as per step S801 of FIG. 8) and the default sequence of class loaders is adjusted (as per step S802 of FIG. 8) so as to override the FindClass method. Once a Java Virtual Machine (JVM) has tried to load the particular class associated with the modified .class file, the customized class loader can intercept the load action, and fill the code portion back to the modified .class file 630 in memory. Once the class has loaded successfully and all bytecode have converted to machine code, then we can erase the code portion we filled into the .class file.

Thus, the processing of the supplementary file 640 so as to load the code portion from the supplementary file 640 may comprise: (a) loading the bytecode of the modified file to memory; (b) creating an instance of a customized class loader including instructions for loading the code portion from the supplementary file; (c) adjusting the default sequence of class loaders such that the customized class loader is called following failure of the default class loader to load the code portion from the modified file; (d) loading the bytecode of the code portion from the supplementary file into memory at a location corresponding to the location of the code portion in the modified file; (e) converting the loaded bytecode of the code portion to machine code; and (f) deleting the loaded bytecode of the code portion from memory.

This is different to the methodology described above for .dex files due to the data structure serialization of .class files; the serialization means that we cannot load the code portion to another part of the heap memory—instead, it is necessary to load the code portion to heap memory at its original location in the .class file stored in the heap. Hence, the protection provided to .class files is slightly weaker than the protection provided to .dex files because the entire .class file exists in memory for a limited time. Nonetheless, if an attacker does not dump the .class file from memory at just the right time, then they will only obtain a corrupted version of the initial .class file 610 (i.e. they will obtain the modified .class file 630). Thus, the present methodology also provides useful protection for Java bytecode.

### 5: Modifications

It will be appreciated that the methods described have been shown as individual steps carried out in a specific order. However, the skilled person will appreciate that these steps may be combined or carried out in a different order whilst still achieving the desired result.

It will be appreciated that embodiments of the invention may be implemented using a variety of different data processing systems. In particular, although the figures and the discussion thereof provide examples relating to .dex files and .class files to be run on DVM/JVM respectively, these are presented merely to provide a useful reference in discussing various aspects of the invention. Embodiments of the invention may be carried out on any suitable data processing device, such as a personal computer, laptop, personal digital assistant, mobile telephone, set top box, television, server computer, etc. Of course, the description of the systems and methods has been simplified for purposes of discussion, and they are just one of many different types of system and method that may be used for embodiments of the invention. It will be appreciated that the boundaries between logic blocks are merely illustrative and that alternative embodiments may merge logic blocks or elements, or may impose an alternate decomposition of functionality upon various logic blocks or elements.

It will be appreciated that the above-mentioned functionality may be implemented as one or more corresponding modules as hardware and/or software. For example, the above-mentioned functionality may be implemented as one or more software components for execution by a processor of the system. Alternatively, the above-mentioned functionality may be implemented as hardware, such as on one or more field-programmable-gate-arrays (FPGAs), and/or one or more application-specific-integrated-circuits (ASICs), and/or one or more digital-signal-processors (DSPs), and/or one or more graphical processing units (GPUs), and/or other hardware arrangements. Method steps implemented in flowcharts contained herein, or as described above, may each be implemented by corresponding respective modules; multiple method steps implemented in flowcharts contained herein, or as described above, may be implemented together by a single module.

It will be appreciated that, insofar as embodiments of the invention are implemented by a computer program, then one or more storage media and/or one or more transmission media storing or carrying the computer program form aspects of the invention. The computer program may have one or more program instructions, or program code, which, when executed by one or more processors (or one or more computers), carries out an embodiment of the invention. The term “program” as used herein, may be a sequence of instructions designed for execution on a computer system, and may include a subroutine, a function, a procedure, a module, an object method, an object implementation, an executable application, an applet, a servlet, source code, object code, byte code, a shared library, a dynamic linked library, and/or other sequences of instructions designed for execution on a computer system. The storage medium may be a magnetic disc (such as a hard drive or a floppy disc), an optical disc (such as a CD-ROM, a DVD-ROM or a BluRay disc), or a memory (such as a ROM, a RAM, EEPROM, EPROM, Flash memory or a portable/removable memory device), etc. The transmission medium may be a communications signal, a data broadcast, a communications link between two or more computers, etc.

1. A method of generating a protected data package from an initial file, the initial file having a predetermined file format, the method comprising:
identifying a code portion of the initial file to be protected;
generating a supplementary file comprising a copy of the code portion; and
modifying the initial file, wherein the modifying comprises replacing at least the code portion of the initial file with replacement data to thereby provide a modified file, wherein the modified file has the same predetermined file format as the initial file, and wherein the modification is arranged to cause a failure when a reader for the predetermined file format tries to load the code portion from the modified file;
wherein the protected data package comprises the modified file and the supplementary file.

2. The method of claim 1, wherein the replacement data comprises random data and/or null data.

3. The method of claim 1, wherein identifying the code portion of the initial file to be protected comprises parsing the initial file to identify the code portion.

4. The method of claim 1, wherein identifying the code portion of the initial file to be protected comprises parsing the initial file to identify a pointer referencing a location of the code portion in the initial file.

5. The method of claim 1, wherein the supplementary file further comprises a pointer which references a location of the code portion in the supplementary file.

6. The method of claim 1, wherein the initial file is a .dex file, wherein the code portion is associated with a particular class of the .dex file.

7. The method of claim 1, wherein the initial file is a dex file, wherein the code portion is associated with a particular method of a particular class of the .dex file.

8. The method of claim 1, wherein the initial file is a Java class file associated with a particular class, and wherein the code portion is associated with a particular method of the particular class.

9. A protected data package generated by:
identifying a code portion of an initial file to be protected, the initial file having a predetermined file format;
generating a supplementary file comprising a copy of the code portion; and
modifying the initial file, wherein the modifying comprises replacing at least the code portion of the initial file with replacement data to thereby provide a modified file, wherein the modified file has the same predetermined file format as the initial file, and wherein the modification is arranged to cause a failure when a reader for the predetermined file format tries to load the code portion from the modified file;
wherein the protected data package comprises the modified file and the supplementary file.

10. A method for a reader of a predetermined file format to execute a protected data package, the protected data package comprising a modified file and a supplementary file, the modified file comprising replacement data that has replaced at least a code portion of an initial file on which the modified file is based, the modified file and the initial file having the predetermined file format, the supplementary file comprising a copy of the code portion, and the method comprising, at runtime:
responsive to a failure when trying to load the code portion from the modified file, processing the supplementary file so as to load the code portion from the supplementary file.

11. The method of claim 10, wherein the replacement data comprises random data and/or null data.

12. The method of claim 10, wherein the replacement data in the modified file comprises first replacement data that replaces the code portion of the initial file, and wherein the failure is caused by the reader for the predetermined file format detecting that the first replacement data includes invalid data for the code portion.

13. The method of claim 10, wherein a pointer in the initial file references a location of the code portion in the initial file, and wherein the replacement data in the modified file comprises second replacement data that replaces the pointer such that the failure is caused by one of:
the reader for the predetermined file format detecting that the second replacement data includes data other than a reference to a file location in the modified file; or
the reader for the predetermined file format detecting that the second replacement data includes a reference to a file location in the modified file, wherein the file location in the modified file includes invalid data for the code portion.

14. The method of claim 10, wherein the initial file is a .dex file, wherein the code portion is associated with a particular class of the .dex file, and wherein the failure occurs when the reader for the predetermined file format uses a default class loader to try to load the code portion from the modified file.

15. The method of claim 14, wherein processing the supplementary file so as to load the code portion from the supplementary file comprises:
creating an instance of a customized class loader including instructions for loading the code portion from the supplementary file; and
adjusting the default sequence of class loaders such that the customized class loader is called following failure of the default class loader to load the code portion from the modified file.

16. The method of claim 10, wherein processing the supplementary file so as to load the code portion from the supplementary file further comprises loading the code portion to heap memory on demand.

17. The method of claim 16, wherein the initial file is a dex file, wherein the code portion is associated with a particular class of the .dex file, wherein the failure occurs when the reader for the predetermined file format uses a default class loader to try to load the code portion from the modified file, and wherein loading the code portion to heap memory on demand comprises:
allocating heap memory for the bytecode of the code portion;
modifying a pointer in the modified file to reference the allocated memory;
loading the bytecode of the code portion to the allocated memory from the supplementary file;
converting the loaded bytecode to machine code;
releasing the allocated memory; and
modifying the pointer in the modified file so that it no longer references the allocated memory.

18. The method of claim 10, wherein the initial file is a Java class file associated with a particular class, wherein the code portion is associated with a particular method of the particular class, and wherein the failure occurs when using the default class loader to try to load the code portion from the modified file.

19. The method of claim 18, wherein processing the supplementary file so as to load the code portion from the supplementary file comprises:
loading the bytecode of the modified file to memory;
creating an instance of a customized class loader including instructions for loading the code portion from the supplementary file;
adjusting the default sequence of class loaders such that the customized class loader is called following failure of the default class loader to load the code portion from the modified file;
loading the bytecode of the code portion from the supplementary file into memory at a location corresponding to the location of the code portion in the modified file;
converting the loaded bytecode of the code portion to machine code;
deleting the loaded bytecode of the code portion from memory.
